(19) United States
(12) Patent Application Publication
(10) Pub. No.: US 2023/0223518 A1
(43) Pub. Date: Jul. 13, 2023

(54) MODIFIED CATHODE FOR HIGH-VOLTAGE LITHIUM-ION BATTERY AND METHODS OF MANUFACTURING THEREOF

(71) Applicants: CORNING INCORPORATED, CORNING, NY (US); Shanghai Institute of Ceramics, Chinese Academy of Sciences, SHANGHAI (CN)

(72) Inventors: Michael Edward Badding, Campbell, NY (US); Mingli Cai, Nantong (CN); Jun Jin, Shanghai (CN); Zhen Song, Painted Post, NY (US); Zhaoyin Wen, Shanghai (CN); Tongping Xiu, Shanghai (CN); Liu Yao, Shanghai (CN)

(21) Appl. No.: 18/008,702

(22) PCT Filed: Jun. 8, 2021
(86) PCT No.: PCT/US2021/036315

§ 371 Date: Dec. 7, 2022

(30) Foreign Application Priority Data
Jun. 11, 2020 (CN) 202010529987.1

(51) Int. Cl. H01M 4/36; H01M 10/0525; H01M 4/525; H01M 4/505; H01M 4/485; H01M 4/131; H01M 10/0562; H01M 10/0563; C01G 53/00

(52) U.S. Cl. CPC H01M 4/366; H01M 10/0525; H01M 4/525; H01M 4/505; H01M 4/485; H01M 4/131; H01M 10/0562; H01M 10/0563; C01G 53/50; H01M 2300/0071; H01M 2300/004; C01P 2002/52; C01P 2006/40; C01P 2004/84; C01P 2002/72; C01P 2004/04

(57) ABSTRACT

A composition includes a first portion including Ni-rich LiNiₓCo_{γ}Mn_{z}O₂, where 0.5<x<1, 0<y<1, 0<z<1; a second portion including Li_{α}Zr_{β}O_{γ}, where 0<α<9, 0<β<3, and 1<γ<10 such that the second portion is coated on the first portion, and the first portion is doped with an elemental metal selected from at least one of Zr, Si, Sn, Nb, Ta, Al, and Fe. A method of forming a composition includes mixing a metal precursor with nickel-cobalt-manganese (NCM) precursor to form a first mixture; adding a lithium-based compound to the first mixture to form a second mixture; and calcining the second mixture at a predetermined temperature for a predetermined time to form the composition.

This application claims the benefit of priority under 35 U.S.C. § 119 of Chinese Patent Application Serial No. 202010529987.1, filed on Jun. 11, 2020, the content of which is relied upon and incorporated herein by reference in its entirety.

### BACKGROUND

### 1. Field

This disclosure relates to modified cathodes for high-voltage lithium-ion batteries (LIBs) and methods of manufacturing thereof.

### 2. Technical Background

Rechargeable lithium-ion batteries (LIBs) have been widely commercialized in portable electronics and electric vehicle applications. Cathode materials play an important role in electrochemical performance and safety of the LIBs.

The present application discloses improved cathodes with high capacity and stability and low cost (and methods of formation thereof) for lithium-ion battery (LIB) applications.

### SUMMARY

In some embodiments, a composition, comprises: a first portion including Ni-rich LiNiₓCo_{y}Mn_{z}O₂, where 0.5<x<1, 0<γ<1, 0<z<1; a second portion including Li_{α}Zr_{β}O_{γ}, where 0<α<9, 0<β<3, and 1<γ<10, wherein: the second portion is coated on the first portion, and the first portion is doped with an elemental metal selected from at least one of Zr, Si, Sn, Nb, Ta, Al, and Fe.

In one aspect, which is combinable with any of the other aspects or embodiments, the second portion comprises at least one of Li₂ZrO₃, Li₄ZrO₄, Li₆Zr₂O₇, Li₈ZrO₆, or combinations thereof.

In one aspect, which is combinable with any of the other aspects or embodiments, the elemental metal is Zr.

In some embodiments, a lithium-ion battery, comprises: a cathode; an electrolyte disposed on the cathode; and a lithium anode disposed on the electrolyte, wherein the cathode comprises: a first portion including Ni-rich LiNiₓCo_{y}Mn_{z}O₂, where 0.5<x<1, 0<γ<1, 0<z<1; a second portion including Li_{α}Zr_{β}O_{γ}, where 0<α<9, 0<β<3, and 1<γ<10, wherein: the second portion is coated on the first portion, and the first portion is doped with an elemental metal selected from at least one of Zr, Si, Sn, Nb, Ta, Al, and Fe.

In one aspect, which is combinable with any of the other aspects or embodiments, the electrolyte is a solid-state electrolyte.

In one aspect, which is combinable with any of the other aspects or embodiments, the solid-state electrolyte comprises: (i) Li₇₋₃ₐLa₃Zr₂LaO₁₂, with L=Al, Ga or Fe and 0<α<0.33; (ii) Li₇La_{3-b}Zr₂MbO₁₂, with M=Bi or Y and 0<b<1; and (iii) Li_{7-c}La₃(Zr_{2-c}N_{c})O₁₂, with N=In, Si, Ge, Sn, V, W, Te, Nb, or Ta and 0<c<1.

In one aspect, which is combinable with any of the other aspects or embodiments, the solid-state electrolyte comprises: Li_{6.4}La₃Zr_{1.4}Ta_{0.6}O₁₂, Li_{6.5}La₃Zr_{1.5}Ta_{0.5}O₁₂, or combinations thereof.

In one aspect, which is combinable with any of the other aspects or embodiments, the solid-state electrolyte comprises: Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li₃PS₄, Li₆PS₅Cl, or combinations thereof.

In one aspect, which is combinable with any of the other aspects or embodiments, the electrolyte is a liquid electrolyte.

In one aspect, which is combinable with any of the other aspects or embodiments, the liquid electrolyte comprises: LiPF₆, LiBF₄, LiClO₄, lithium chelatoborates (e.g., lithium bis(oxalato)borate), electrolyte additive agents, fluoroethylene carbonate (FEC), tris(trimethylsilyl)phosphate (TMSP), vinylene carbonate (VC), or combinations thereof, in an organic solvent.

In one aspect, which is combinable with any of the other aspects or embodiments, the second portion comprises at least one of Li₂ZrO₃, Li₄ZrO₄, Li₆Zr₂O₇, Li₈ZrO₆, or combinations thereof.

In one aspect, which is combinable with any of the other aspects or embodiments, the elemental metal is Zr.

In one aspect, which is combinable with any of the other aspects or embodiments, the battery is configured to exhibit a capacity retention of at least 91.6% after 100 cycles at a rate of 2 C over 2.8V to 4.5V; or a capacity retention of at least 93.7% after 20 cycles at a rate of 0.2 C over 2.8V to 4.5V.

In one aspect, which is combinable with any of the other aspects or embodiments, the battery is further configured to exhibit a discharge capacity of at least 159.6 mAhg⁻¹.

In some embodiments, a method of forming a composition, comprises: mixing a metal precursor with nickel-cobalt-manganese (NCM) precursor to form a first mixture; adding a lithium-based compound to the first mixture to form a second mixture; and calcining the second mixture at a predetermined temperature for a predetermined time to form the composition.

In one aspect, which is combinable with any of the other aspects or embodiments, the composition comprises: a first portion including Ni-rich LiNiₓCo_{y}Mn_{z}O₂, where 0.5<x<1, 0<γ<1, 0<z<1; a second portion including Li_{α}Zr_{β}O_{γ}, where 0<α<9, 0<β<3, and 1<γ<10, wherein: the second portion is coated on the first portion, and the first portion is doped with an elemental metal selected from at least one of Zr, Si, Sn, Nb, Ta, Al, and Fe.

In one aspect, which is combinable with any of the other aspects or embodiments, the metal precursor is selected from at least one of a Zr-, Si-, Sn-, Nb-, Ta-, Al-, and Fe-precursor.

In one aspect, which is combinable with any of the other aspects or embodiments, the metal precursor is a Zr-precursor.

In one aspect, which is combinable with any of the other aspects or embodiments, the lithium-based compound is selected from at least one of Li₂CO₃, LiOH, LiNO₃, and CH₃COOLi.

In one aspect, which is combinable with any of the other aspects or embodiments, the predetermined temperature is in a range of 700° C. to 1200° C. and the predetermined time is in a range of 8 hrs to 15 hrs.

### BRIEF DESCRIPTION OF THE DRAWINGS

The disclosure will become more fully understood from the following detailed description, taken in conjunction with the accompanying figures, in which:

FIG. 1 illustrates a general structure of a high-voltage lithium-ion battery (LIB), according to some embodiments.

FIG. 2 illustrates a schematic diagram of a synthetic process for forming modified NCM622 particles, according to some embodiments.

FIG. 3 illustrates x-ray diffraction (XRD) patterns of cathodes comprising modified NCM622 material with varying contents of UiO-66, according to some embodiments.

FIG. 4 illustrates a transmission electron microscopy (TEM) image of a cathode comprising modified NCM622 material, according to some embodiments.

FIG. 5 illustrates Rietveld refinement results of cathodes comprising modified NCM622 material, as in Sample 1 and Sample 2, according to some embodiments.

FIG. 6 illustrates cycling stability of Sample 1 and Comparative Sample 1, according to some embodiments.

FIG. 7 shows the rate performance of Sample 1 and Comparative Sample 1, according to some embodiments.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

The present disclosure relates to high-voltage LIBs, and more particularly to modified, Ni-rich LiNiₓCo_{y}Mn_{z}O₂ (NCM, 0.5<x<1, 0<γ<1, 0<z<1) cathode-based high voltage batteries. In some embodiments, the high-voltage LIB may comprise modified NCM (e.g., LiNi_{0.6}Co_{0.2}Mn_{0.2}O₂) coated with LZO (e.g., Li_{α}Zr_{β}O_{γ}, 0<α<9, 0<β<3, and 1<γ<10) and/or elementally doped with a metal (e.g., Zr, Si, Sn, Nb, Ta, Al, Fe, etc.) to enhance cycling stability and rate capacity of the battery.

It is contemplated that NCM may be used as a promising cathode material due to its high energy density, low cost, and increased specific capacity. However, surface structural degradation of NCM accelerates at elevated voltages, causing LIB capacity fading and safety issues. Aiming at solving these problems, the present specification discloses a surface coating to effectively inhibit unwanted side reactions within the LIB and a doping scheme to enhance the structural stability.

FIG. 1 illustrates a general structure of a high-voltage lithium-ion battery (LIB), according to some embodiments. It will be understood by those of skill in the art that the processes described herein can be applied to other configurations of LIB structures.

In some embodiments, battery 100 may include a substrate 102 (e.g., a current collector), a cathode 104 disposed on the substrate, an optional coating layer 114 disposed on the cathode, an optional first interlayer 106 disposed on the coating layer, a electrolyte 108 (e.g., solid-state and/or liquid electrolytes) disposed on the first interlayer, an optional second interlayer 110 disposed on the electrolyte, a lithium electrode (e.g., anode) 112 disposed on the second interlayer, and a second current collector 116 disposed on the anode. These can be disposed horizontally in relation to each other or vertically.

In some examples, the substrate 102 may a current collector including at least one of three-dimensional nickel (Ni) foam, carbon fiber, foils (e.g., aluminum, stainless steel, copper, platinum, nickel, etc.), or a combination thereof.

In some examples, the interlayer 106 and 110 may be independently chosen from at least one of carbon-based interlayers (e.g., interlinked freestanding, micro/mesopore containing, functionalized, biomass derived), polymer-based interlayers (e.g., PEO, polypyrrole (PPY), polyvinylidene fluoride, etc.), metal-based (e.g., Ni foam, etc.), or a combination thereof. In some examples, at least one of interlayers 106 or 110 may be PEO₁₈LiTFSI-10% SiO₂-10% IL (combination of polyethylene oxide (PEO), bis(trifluoromethane) sulfonimide lithium salt (LiN(CF₃SO₂)₂, or LiTFSI), SiO₂ nanoparticles and ionic liquid (IL)).

In some examples, electrolyte 108 may be solid-state electrolytes, which have attracted ever-increasing attention because they are able to address common safety concerns such as leakage, poor chemical stability, and flammability often seen in LIBs employing liquid electrolytes, especially under exertive conditions like extended operational time frames and elevated cycling temperatures. For example, LLZO-based electrolytes have high ionic conductivity and wide electrochemical windows, which are desirable for solid-state high-voltage LIBs.

In some examples, the solid-state electrolyte may include at least one of LLZO-based (i.e., compounds comprising lithium, lanthanum, zirconium, and oxygen elements such as at least one of (i) Li₇₋₃ₐLa₃Zr₂LaO₁₂, with L=Al, Ga or Fe and 0<α<0.33; (ii) Li₇La_{3-b}Zr₂MbO₁₂, with M=Bi or Y and 0<b<1; (iii) Li_{7-c}La₃(Zr_{2-c}N_{c})O₁₂, with N=In, Si, Ge, Sn, V, W, Te, Nb, or Ta and 0<c<1 (e.g., Li_{6.4}La₃Zr_{1.4}Ta_{0.6}O₁₂, Li_{6.5}La₃Zr_{1.5}Ta_{0.5}O₁₂, etc.); or combinations thereof), Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li₃PS₄, Li₆PS₅Cl, or combinations thereof. Methods of formation of the electrolyte 108 are described in the Examples below.

In some examples, the anode 112 may comprise lithium (Li) metal. In some examples, the battery may include at least one anode protector such as electrolyte additives (e.g., LiNO₃, lanthanum nitrate, copper acetate, P₂S₅, etc.), artificial interfacial layers (e.g., Li₃N, (CH₃)₃SiCl, Al₂O₃, LiAl, etc.), composite metallics (e.g., Li₇B₆, Li-rGO (reduced graphene oxide), layered Li-rGO, etc.), or combinations thereof. In some examples, a thin layer of metal (e.g., Au) may be ion-sputter coated to form a contact interface between the anode 112 and first interlayer 106 or between the anode and electrolyte 108. In some examples, a thin layer of silver (Ag) paste may be brushed to a surface of the electrolyte 108 to form a close contact between the anode 112 and electrolyte 108.

In some examples, the coating layer 114 may comprise at least one of carbon polysulfides (CS), polyethylene oxides (PEO), polyaniline (PANT), polypyrrole (PPY), poly(3,4-ethylenedioxythiophene) (PEDOT), polystyrenesulfonic acid (PSS), polyacrylonitrile (PAN), polyacrylic acid (PAA), polyallylamine hydrochloride (PAH), poly(vinylidene fluoride-co-hexafluoropropylene) (P(VdF-co-HFP)), poly(methylmethacrylate) (PMMA), polyvinylidene fluoride (PVDF), poly(diallyldimethyl ammonium) bis(trifluoromethanesulfonyl)imide (TF SI) (PDDATF SI), lithium salts (e.g., bis(trifluoromethane) sulfonimide lithium salt (LiN(CF₃SO₂)₂)(LiTFSI), lithium perchlorate, lithium bis(oxalato) borate (LiBOB), lithium bis(fluorosulfonyl)imide (LiFSI), lithium trifluoromethanesulfonate (LiCF₃SO₃) (LiTf), lithium bis(trifluoromethanesulfonimide) (Li(C₂F₅SO₂)₂N) (LiBETI), etc.), or combinations thereof.

In some examples, the coating layer 114 may comprise a lithium-rich additive (e.g., Li_{α}Zr_{β}O_{γ}, 0<α<9, 0<β<3, and 1<γ<10), such as Li₂ZrO₃, Li₄ZrO₄, Li₆Zr₂O₇, Li₈ZrO₆, etc. In some examples, where the lithium-rich additive coating layer directly contacts a solid-state LLZO-based electrolyte, the lithium-rich additive coating layer may help to reduce the sintering temperature of the LLZO-based electrolyte and create a lithium atmosphere during electrolyte sintering, which simplifies the sintering process and reduces its cost.

Description of the cathode 104 and methods of formation are described in the Examples below.

### EXAMPLES

As explained in the examples below, a kind of co-modified NCM cathode with a Li_{α}Zr_{β}O_{γ} coating and elemental Zr doping is disclosed for high-voltage lithium-ion batteries. This cathode was prepared by a facile one-step method using a Zr precursor (UiO-66, a kind of zirconium metal-organic framework (Zr-MOF)) and nickel-cobalt-manganese (NCM) precursor (NCM-OH; where Ni_{d}CoₑMn_{f}(OH)₂, 0.5<d<1, 0<e<1, 0<f<1). The modified NCM cathode exhibits a greatly enhanced cycling stability (capacity retention of 91.6% after 100 cycles at 2 C) with high upper cut-off voltage of 4.5V in liquid electrolyte battery due to the Li_{α}Zr_{β}O_{γ} coating and Zr doping. Quasi-solid-state batteries based on this type of cathode delivered discharge capacity of 180.2 mAhg⁻¹ with high capacity retention of 95.4% after 20 cycles at 0.2 C over 2.8-4.5 V.

### Example 1—Preparation of Zirconium Precursors

Zirconium chloride (ZrCl₄, >98%) and terephthalic acid (H₂BDC, >98%) were dissolved in N,N-dimethylformamide (DMF, AR, >99.5%), thereafter transferred into a Teflon-lined stainless steel autoclave and reacted for 24 h at 120° C. in homogeneous reactor. After cooling to room temperature, the mother liquor was decanted and the product was washed by DMF and methanol repeatedly. After washing, the product was dried at 393K overnight to obtain the crystalline UiO-66 material (i.e., C₄₈H₂₈O₃₂Zr₆). In some examples, alternatives to zirconium precursors may be used such as: Zn-precursors (e.g., ZIF-8), Fe- and Al-precursors (e.g., MIL-100), Al-precursors (e.g., MIL-53), and Cr-precursors (e.g., MIL-101).

### Example 2—Preparation of Modified Nickel-Cobalt-Manganese (NCM) Powders

Precursor powders NCM-OH (e.g., Ni_{0.6}Co_{0.2}Mn_{0.2}(OH)₂) (diameter, Φ=3-20 μm) were mixed with varying amounts of UiO-66 materials: 0 wt. %, 2 wt. % to 4 wt. % (e.g., 2.5 wt. %), 4 wt. % to 8 wt. % (e.g., 5 wt. %), and 8 wt. % to 12 wt. % (e.g., 10 wt. %) (Φ<800 nm) by ball-milling at a speed of 250 rpm. Then, lithium carbonate (Li₂CO₃) (>98%, 5% excess) was added by hand grinding in an agate mortar for 15 min. Lithium-based compounds are used as a lithium source to react with both NCM-OH and UiO-66 to obtain NCM particles comprising a Li_{α}Zr_{β}O_{γ} coating layer. Other lithium compounds that can also be used are LiOH, LiNO₃, and CH₃COOLi.

Thereafter, the mixture (NCM-OH, UiO-66, and Li₂CO₃) was calcinated at 850° C. for 12 hrs in oxygen to obtain modified NCM622 powders. Zirconium substitutes in for transition metal sites during the high temperature sintering process (“Zr-doped”).

In some examples, the calcining temperature is in a range of 700° C. to 1200° C. (e.g., 850° C.), or 700° C. to 1000° C., or 700° C. to 900° C., or any value or range disposed therein. In some examples, the calcining time is in a range of 8 hrs to 15 hrs (e.g., 12 hrs), or 10 hrs to 15 hrs, 10 hrs to 13 hrs, or any value or range disposed therein.

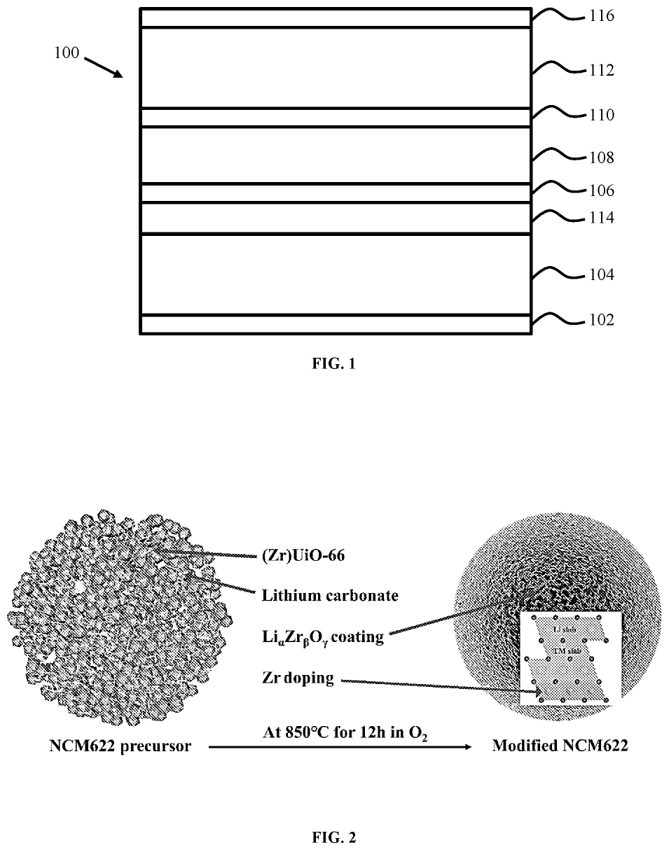

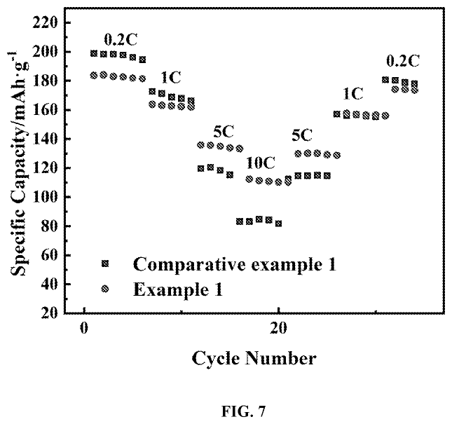

FIG. 2 illustrates a schematic diagram of a synthetic process for forming modified NCM622 particles, according to some embodiments. The porous framework (i.e., the three-dimensional (3-D) interconnected networks) of UiO-66 is maintained in the modified NCM622 particles, which enhances lithium ion diffusion (quantified by the parameter D_{Li+} (cm² s⁻¹) in Table 2 below) and electron transfer. With regard to electron transfer enhancement, it can be compared from the rate performance, as shown in FIG. 7. At high rate of 10 C, Sample 1 has a discharge capacity of 112.3 mAh g⁻¹ (61%) while Comparative Sample 1 has a discharge capacity of only about 83.2 mAh g⁻¹ (43%), indicating the electron transfer enhancement of modified NCM.

The general chemistry of how calcination of NCM-OH, UiO-66, and Li₂CO₃ leads to a final product of modified NCM (LiNi_{0.6}Co_{0.2}Mn_{0.2}O₂) coated with Li_{α}Zr_{β}O_{γ} and elementally doped with Zr is shown below is equations 1 and 2.

NCM-OH+Li₂CO₃→NCM+CO₂+H₂O (Eq.1)

UiO-66(Zr)+Li₂CO₃→Li_{α}Zr_{β}O_{γ}+CO₂+H₂ (Eq.2)

The diameter of the Li_{α}Zr_{β}O_{γ} coating varies in a range of 3 nm to 100 nm. Lithium-ion diffusion at the cathode/electrolyte interface is suppressed if the coating layer is too thick.

### Example 3—Preparation of Modified NCM Cathodes

Modified NCM-based cathodes are made up of 80 wt. % active material (i.e., the cathode material—the synthesized modified NCM), 10 wt. % poly(vinylidene difluoride) binder in N-methyl-2-pyrrolidone (NMP), 5 wt. % conductive carbon (e.g., super P, Ketjen black, or combinations thereof) and 5 wt. % vapor-grown carbon fibers (VGCF). VGCF is a type of carbon fiber material with one-dimensional morphology. The obtained slurry was cast on aluminum foil and dried overnight at 65° C. under vacuum to remove NMP. Then disc electrodes of 12 mm in diameter were punched, resulting in an average active material mass loading of 3 mg/cm² to 4 mg/cm². The cathode material is a contributor of capacity. NMP is a solvent to dissolve poly(vinylidene difluoride) binder, whose function is to adhere the slurry to the Al current. Conductive carbon with different shapes aim to construct increased electrical contact.

### Example 4—Preparation of Modified NCM Cathode-Liquid Electrolyte-Li Anode Battery

CR-2025-type coin cells were assembled with the disc cathodes of Example 3, monolayer polypropylene (PP) separator membranes, lithium foil anode, and liquid electrolyte of 1M LiPF₆ in ethylene carbonate-dimethyl carbonate-diethyl carbonate (EC-DMC-DEC; 1:1:1 v/v/v).

### Example 5—Preparation of LLZO-Based Solid-State Electrolyte

Precursor powder LiOH·H₂O (AR, 2% excess), La₂O₃ (99.99%, calcined at 900° C. for 12 hrs), ZrO₂ (AR), and Ta₂O₅ (99.99%) were weighed according to the stoichiometric ratio of Li_{6.5}La₃Zr_{1.5}Ta_{0.5}O₁₂. Wet ball milling was carried out for 12 hrs using yttrium-stabilized zirconia (YSZ) balls as a grinding medium at a speed of 250 rpm using isopropanol as the solvent. The dried mixture power was calcined in an alumina crucible at 950° C. for 6 hrs to obtain pure cubic Li-garnet electrolyte powder. The powder was ball milled at 250 rpm for 24 hrs to obtain refined powder. Then the refined powder was pressed and calcined at 1250° C. for 30 min in a platinum crucible in air. The pellets were polished with first 400 grit and second 1200 grit sandpaper and stored in an Ar-filled glove box. The final pellet thickness is 700 μm.

### Example 6—Preparation of Modified NCM Cathode-LLZO-Based Solid-State Electrolyte-Li Anode Battery

CR-2025-type coin cells were assembled with the discs of Example 3, monolayer polypropylene (PP) separator membranes, lithium foil anode, LLZO-based cathode of Example 5, and 30 μL liquid electrolyte of 1M LiPF₆ in ethylene carbonate-dimethyl carbonate-diethyl carbonate (EC-DMC-DEC, 1:1:1 v/v/v) to wet the cathode/electrolyte interface and electrolyte/anode interface.

### Example 7—Characterization of Example 4 and Example 6

Morphology and Phase Analysis

Transmission electron microscopy (TEM) images were obtained by scanning electron microscope (TEM, Tecnai G2 F20). X-ray diffraction (XRD) patterns were characterized by obtained by X-ray powder diffraction (Rigaku, Ultima IV, nickel-filtered Cu-Kα radiation, λ=1.542 Å) in the 20 range of 10-80° at room temperature. The lattice parameter refinements were carried out using GSAS-EXPGUI software. X-ray photoelectron spectroscopy (XPS) was conducted by an ESCAlab250 system.

Electrochemical Impedance Spectroscopy

Electrochemical impedance spectroscopy (EIS) tests were conducted with an electrochemical workstation (Autolab, Model PGSTAT302N) in a frequency range from 105 Hz to 0.1 Hz. Simulated values of Rₛ and R_{ct} were carried out by NOVA software. Lithium diffusion coefficients (D_{Li}) were evaluated according to equations 3 and 4.

$$\begin{matrix}{Z}^{′} = {R}_{s} + {R}_{ct} + {σω}^{- 1 / 2} & ( Eq \text{.3} ) \\ {D}_{Li} = \frac{{R}^{2} {T}^{2}}{2 {A}^{2} {n}^{4} {F}^{4} {C}^{2} {σ}^{2}} & ( Eq . 4 )\end{matrix}$$

Here, Warburg impedance coefficients (a) was obtained by the slope of the linear fitting results of Z′ and ω^{-1/2} in equation 3 and then applied in equation 4, where R represents gas constant (8.314 J K⁻¹ mol⁻¹), T is temperature (298.15 K), and A is the efficient work area of the cathode. n is the number of electrons, F is the Faraday constant (96485 C mol⁻¹), and C is the concentration of Li+ ions in the cathode.

Electrochemical Performance

All the batteries were measured with LAND CT2001A battery test system (China) in a voltage range from 2.8V to 4.5V. Liquid batteries (Example 4) were activated at 0.2 C for four cycles before measurements were conducted at a current density of 2 C. The quasi-solid-batteries (Example 6) were all activated at 0.1 C for three cycles before measurements were conducted at a current density of 0.2 C. Rate performance was carried out with the current density from 0.2 C, 1 C, 5 C to 1 C and then gradually decreased back to 0.2 C from five cycles.

Sample 1—Liquid Electrolyte Battery

Precursor powders NCM-OH (Ni_{0.6}Co_{0.2}Mn_{0.2}(OH)₂) were mixed with 2.5 wt. % UiO-66 material by ball-milling at a speed of 250 rpm. Then, Li₂CO₃ (>98%, 5% excess) was added by hand grinding in an agate mortar for 15 min. Thereafter, the mixture (NCM-OH, UiO-66, and Li₂CO₃) was calcinated at 850° C. for 12 hrs in oxygen to obtain modified NCM622 powders.

The slurry comprises 80 wt. % modified NCM622, 10 wt. % poly(vinylidene difluoride) binder in NMP, 5 wt. % super P, and 5 wt. % VGCF. The obtained slurry was cast on aluminum foil and dried overnight at 65° C. under vacuum, and disc cathodes of 12 mm in diameter were punched. CR-2025-type coin cells were assembled with the disc cathodes, monolayer polypropylene (PP) separator membranes, lithium foil anode, and liquid electrolyte of 1M LiPF₆ in ethylene carbonate-dimethyl carbonate-diethyl carbonate (EC-DMC-DEC; 1:1:1 v/v/v).

Sample 2—Quasi-Solid-State Electrolyte Battery

Same as Sample 1 (e.g., 2.5 wt. % UiO-66), except the electrolyte is LLZO-based combined with 30 μL liquid electrolyte instead of a solely liquid electrolyte (as in Sample 1). LLZO pellets were prepared as in Example 5.

Sample 3—Quasi-Solid-State Electrolyte Battery

Same as Sample 2, except the UiO-66 content is 5 wt. %.

Sample 4—Quasi-Solid-State Electrolyte Battery

Same as Sample 2, except the UiO-66 content is 10 wt. %.

Comparative Sample 1—Liquid Electrolyte Battery

Same as Sample 1, except the UiO-66 content is 0 wt. %.

Comparative Sample 2—Quasi-Solid-State Electrolyte Battery

Same as Sample 2, except the UiO-66 content is 0 wt. %.

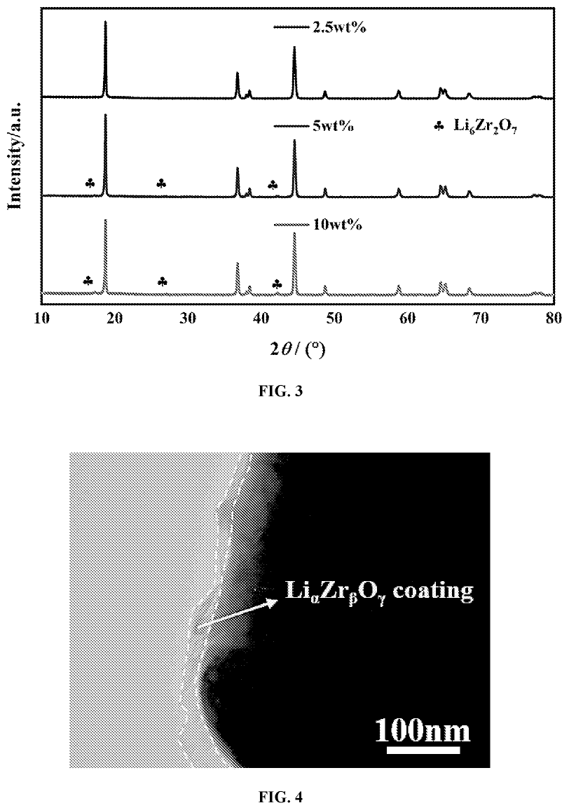

Turning now to the figures, FIG. 3 illustrates x-ray diffraction (XRD) patterns of cathodes comprising modified NCM622 material with 2.5 wt. % (Sample 2), 5 wt. % (Sample 3), and 10 wt. % (Sample 4) UiO-66. All the diffraction peaks are matched well with a typical hexagonal a-NaFeO₂ structure (JCPDF card no. 01-089-4533 with R-3m space group), which refers to the main phase of NCM622. An a-NaFeO₂-type crystal structure is of an ordered rock-salt type such that Li and Me ions occupy alternate (111) layers. NCM has a layered NaFeO₂ structure with R-3m space group with alternating layers formed by edge-sharing LiO₆ and MO₆ octahedra. From FIG. 3, the major diffraction peaks of all samples match well with JCPDF cards with R-3m space group. A representative formula of the modified Ni-rich NCM may be LiNiₓCo_{y}Mn_{z}AₙO₂, where 0.5<x<1, 0<γ<1, 0<z<1, 0≤n<0.04, A (the dopant)=Zr, Si, Sn, Nb, Ta, Al, and Fe. When the content of UiO-66 increases from 2.5 wt. % to 5 wt. % or 10 wt. %, extra peaks of Li₆Zr₂O₇ are detected, as in Example 3 and Example 4, respectively. Because more UiO-66 provides more Zr to react with Li₂CO₃, more Li₆Zr₂O₇ is obtained. Only when UiO-66 content increases are the peaks of Li₆Zr₂O₇ detectable, which confirms existence of the Li_{α}Zr_{β}O_{γ} coating layer. It is concluded that the main phase of NCM622 does not change and a new second phase occurs in the modified NCM622 material. More Li₆Zr₂O₇ does not change the layered structure of modified NCM622 material because peaks related to the NCM622 phase are not shifted.

FIG. 4 illustrates a transmission electron microscopy (TEM) image of a cathode comprising modified NCM622 material with 5 wt. % UiO-66 (Sample 3) and shows the presence of a thin Li_{α}Zr_{β}O_{γ} coating layer in a range of approximately 10 nm to 50 nm on the surface of the host material, confirming the XRD results of FIG. 3.

FIG. 5 and Table 1 (below) illustrate Rietveld refinement results of cathodes comprising modified NCM622 material, as in Sample 1 and Sample 2. Rietveld refinement is a technique used to characterize crystalline materials. Neutron diffraction and XRD of powder samples results in patterns characterized by reflections (peaks in intensity) at certain positions. The height, width and position of these reflections are used to determine aspects of the material's structure, such as unit cell dimensions, phase quantities, crystallite sizes/shapes, atomic coordinates/bond lengths, micro strain in crystal lattice, texture, and vacancies.

The drawback of powder XRD is a severe peak overlap, causing loss of structural information. In contrast, Rietveld refinement results reflect refined crystal structure parameters on basis of the least square approach. Regarding elemental doping, Rietveld refinement is an important and reliable technique for studying changes in cell parameters, unit cell volume, and atomic occupation.

TABLE 1

| | a/Å | b/Å | c/Å | V/Å³ |
|---|---|---|---|---|
| Comparative Samples 1 and 2 | 2.8668 | 2.8668 | 14.1915 | 101.014 |
| Samples 1 and 2 | 2.8670 | 2.8670 | 14.2162 | 101.199 |

Since Rietveld refinement depends on finding the best fit between a calculated and experimental pattern, numerical figures of merit have been developed to quantify the quality of the fit. Profile residual (reliability factor) (Rₚ, <15%) and goodness of fit (X², <4) are two figures of merit that may be used to characterize the quality of a Rietveld refinement; they provide insight to how well the model fits the observed data.

Sample 1 and Comparative Sample 1 show a Rₚ of 7.21% and 9.10%, respectively, a X² of 1.807 and 2.931, respectively. The obtained cell parameters and cell volume of modified NCM622 in Sample 1 are larger than that in Comparative Sample 1, suggesting that Zr doping changes the lattice structure in Samples 1 and 2. Sample 2 uses the same powder as Sample 1, but is applied to a separate battery.

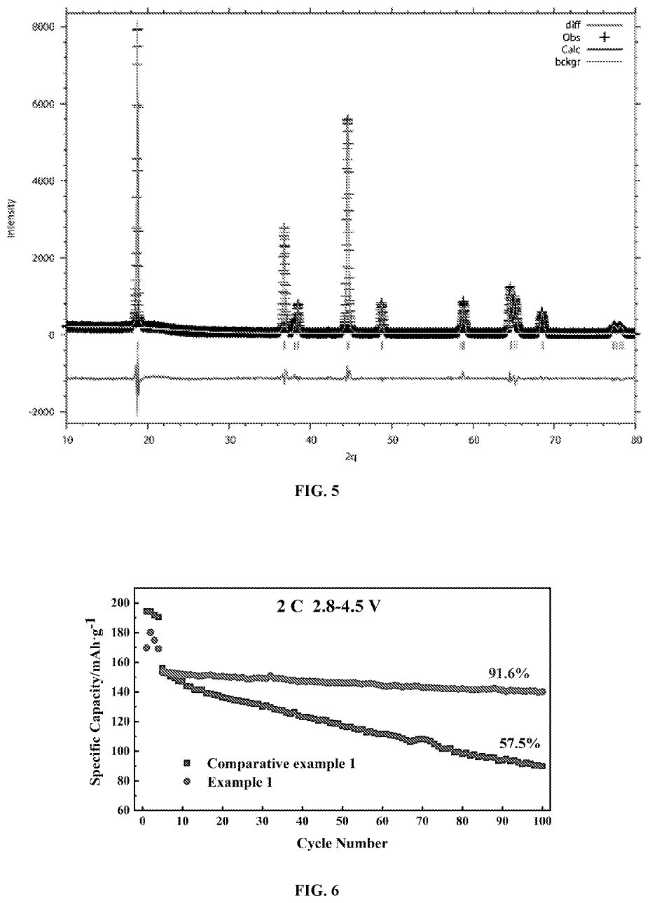

FIG. 6 illustrates cycling stability of Sample 1 and Comparative Sample 1. Activated by four charge/discharge cycles at 0.2 C, the liquid electrolyte battery of Sample 1 (comprising 2.5 wt. % UiO-66) shows a superior capacity retention of 91.6% at high rate of 2 C over 2.8V to 4.5V after 100 cycles, which is much higher than a capacity retention of 57.5% for Comparative Sample 1. Thus, the co-modified NCM622 cathode has improved electrochemical properties due to the Li_{α}Zr_{β}O_{γ} coating and Zr doping.

Table 2 lists the electrochemical performance of Comparative Sample 2 and Samples 2-4.

TABLE 2

| | | | Discharge | Capacity | |
|---|---|---|---|---|---|
| | | | capacity | retention | |
| | UiO-66 | | (mAh g⁻¹) | (%) | |
| Sample | Content | | (after 20 cycles) | | D_{Li+}(cm² s⁻¹) |
| Comparative | 0 | wt. % | 121.3 | 65.3% | 1.4377 × 10⁻¹³ |
| Sample 2 | | | | | |
| 2 | 2.5 | wt. % | 159.6 | 93.7% | 4.3967 × 10⁻¹³ |
| 3 | 5 | wt. % | 180.2 | 95.4% | 1.7164 × 10⁻¹² |
| 4 | 10 | wt. % | 163.3 | 95.3% | 3.1211 × 10⁻¹³ |

Compared to the capacity retention of Comparative Sample 2 (65.3%), the modified NCM622 cathodes with at least some content of UiO-66 exhibit elevated capacity retentions of 93.7%, 95.4% and 95.3% for Sample 2, Sample 3, and Sample 4, respectively, after 20 cycles at 0.2 C over 2.8V to 4.5V. The enhanced cycling stability of modified NCM622 in the quasi-solid-state battery (Samples 2-4) can be ascribed to improved lithium ion diffusion supported by the data of Du in Table 2, which confirms the advantage of Li_{α}Zr_{β}O_{γ} coating and Zr doping.

FIG. 7 shows the rate performance of Sample 1 and Comparative Sample 1. At high rate of 10 C, Sample 1 has a discharge capacity of 112.3 mAh g⁻¹ (61%) while Comparative Sample 1 has a discharge capacity of only about 83.2 mAh g⁻¹ (43%), indicating the electron transfer enhancement of modified NCM.

Regarding Li-ion diffusion and cycling stability, charging and discharging is a process, along with electron transfer and Li-ion diffusion, at the interface and in the bulk of the material. The ability of Li-(de)intercalation and electron transfer determines diffusion polarization, ohmic polarization and activation polarization to a large extent, and polarization is an important dynamic reason for capacity retention. Regarding Li-ion diffusion and presence of Li_{α}Zr_{β}O_{γ} coating and Zr doping, the lithium compound (Li_{α}Zr_{β}O_{γ}) coating is preferable to other common coating materials because of enhanced Li-ion diffusivity at the interface while Zr doping enlarges the unit cell, making Li-ion diffusion in the bulk material more easy. Among Samples 2-4, the battery in Example 3 delivered the highest discharge capacity due to an optimal content of coating and doping.

In some examples, the formed battery exhibits a capacity retention of at least 40%, or at least 50%, or at least 60%, or at least 70%, or at least 80%, or at least 90%, or at least 95%, or at least 99%, or any value or range disclosed therein, after 20 cycles.

Thus, as presented herein, this disclosure relates to improved cathodes with high capacity and stability and low cost (and methods of formation thereof) for lithium-ion battery (LIB) applications. In other words, a co-modified NCM cathode with a Li_{α}Zr_{β}O_{γ} coating and elemental Zr doping is disclosed for both liquid electrolyte and solid-state electrolyte LIBs. This cathode was prepared by a facile one-step method using a Zr precursor (UiO66, a kind of zirconium metal-organic framework (Zr-MOF)) and nickel-cobalt-manganese (NCM) precursor (NCM-OH). The modified NCM cathode exhibits a greatly enhanced cycling stability (capacity retention of 91.6% after 100 cycles at 2 C) with high upper cut-off voltage of 4.5V in liquid electrolyte battery due to the Li_{α}Zr_{β}O_{γ} coating and Zr doping. Quasi-solid-state batteries based on this type of cathode delivered discharge capacity of 180.2 mAhg⁻¹ with high capacity retention of 95.4% after 20 cycles at 0.2 C over 2.8-4.5 V.

Advantages include (1) a dual-modified NCM cathode with both Li_{α}Zr_{β}O_{γ} coating and Zr doping; (2) a Zr precursor to modify the NCM precursor to realize a one-step process to obtain both doped and coated NCM powders; (3) the Li_{α}Zr_{β}O_{γ} coating layer has great lithium ion diffusivity; (4) the porous framework of Li_{α}Zr_{β}O_{γ} coating layer provides excessive active sites for electron transfer; and (5) no usage of any organic solvent makes the method non-destructive to NCM particles and environmentally friendly.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be apparent to those skilled in the art that various modifications and variations can be made without departing from the spirit or scope of the claimed subject matter. Accordingly, the claimed subject matter is not to be restricted except in light of the attached claims and their equivalents.

1. A composition, comprising:
a first portion including Ni-rich LiNiₓCo_{y}Mn_{z}O₂, where 0.5<x<1, 0<γ<1, 0<z<1;
a second portion including Li_{α}Zr_{β}O_{γ}, where 0<α<9, 0<β<3, and 1<γ<10
wherein:
the second portion is coated on the first portion, and
the first portion is doped with an elemental metal selected from at least one of Zr, Si, Sn, Nb, Ta, Al, and Fe.

2. The composition of claim 1, wherein the second portion comprises at least one of Li₂ZrO₃, Li₄ZrO₄, Li₆Zr₂O₇, Li₈ZrO₆, or combinations thereof.

3. The composition of claim 1, wherein the elemental metal is Zr.

4. A lithium-ion battery, comprising:
a cathode;
an electrolyte disposed on the cathode; and
a lithium anode disposed on the electrolyte,
wherein the cathode comprises:
a first portion including Ni-rich LiNiₓCo_{y}Mn_{z}O₂, where 0.5<x<1, 0<γ<1, 0<z<1;
a second portion including Li_{α}Zr_{β}O_{γ}, where 0<α<9, 0<β<3, and 1<γ<10,
wherein:
the second portion is coated on the first portion, and
the first portion is doped with an elemental metal selected from at least one of Zr, Si, Sn, Nb, Ta, Al, and Fe.

5. The battery of claim 4, wherein the electrolyte is a solid-state electrolyte.

6. The battery of claim 5, wherein the solid-state electrolyte comprises:
(i) Li₇₋₃ₐLa₃Zr₂LaO₁₂, with L=Al, Ga or Fe and 0<α<0.33;
(ii) Li₇La_{3-b}Zr₂MbO₁₂, with M=Bi or Y and 0<b<1; or
(iii) Li_{7-c}La₃(Zr_{2-c}N_{c})O₁₂, with N=In, Si, Ge, Sn, V, W, Te, Nb, or Ta and 0<c<1.

7. The battery of claim 5, wherein the solid-state electrolyte comprises: Li_{6.4}La₃Zr_{1.4}Ta_{0.6}O₁₂, Li_{6.5}La₃Zr_{11.5}Ta_{0.5}O₁₂, or combinations thereof.

8. The battery of claim 5, wherein the solid-state electrolyte comprises: Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li₃PS₄, Li₆PS₅Cl, or combinations thereof.

9. The battery of claim 4, wherein the electrolyte is a liquid electrolyte.

10. The battery of claim 9, wherein the liquid electrolyte comprises: LiPF₆, LiBF₄, LiClO₄, lithium chelatoborates, electrolyte additive agents, fluoroethylene carbonate (FEC), tris(trimethylsilyl)phosphate (TMSP), vinylene carbonate (VC), or combinations thereof, in an organic solvent.

11. The battery of claim 4, wherein the second portion comprises at least one of Li₂ZrO₃, Li₄ZrO₄, Li₆Zr₂O₇, Li₈ZrO₆, or combinations thereof.

12. The battery of claim 4, wherein the elemental metal is Zr.

13. The battery of claim 4, configured to exhibit a capacity retention of at least 91.6% after 100 cycles at a rate of 2 C over 2.8V to 4.5V; or a capacity retention of at least 93.7% after 20 cycles at a rate of 0.2 C over 2.8V to 4.5V.

14. The battery of claim 13, further configured to exhibit a discharge capacity of at least 159.6 mAhg⁻¹.

15. A method of forming a composition, comprising:
mixing a metal precursor with nickel-cobalt-manganese (NCM) precursor to form a first mixture;
adding a lithium-based compound to the first mixture to form a second mixture; and
calcining the second mixture at a predetermined temperature for a predetermined time to form the composition.

16. The method of claim 15, wherein the composition comprises:
a first portion including Ni-rich LiNiₓCo_{y}Mn_{z}O₂, where 0.5<x<1, 0<γ<1, 0<z<1;
a second portion including Li_{α}Zr_{β}O_{γ}, where 0<α<9, 0<β<3, and 1<γ<10
wherein:
the second portion is coated on the first portion, and
the first portion is doped with an elemental metal selected from at least one of Zr, Si, Sn, Nb, Ta, Al, and Fe.

17. The method of claim 15, wherein the metal precursor is selected from at least one of a Zr-, Si-, Sn-, Nb-, Ta-, Al-, and Fe-precursor.

18. The method of claim 17, wherein the metal precursor is a Zr-precursor.

19. The method of claim 15, wherein the lithium-based compound is selected from at least one of Li₂CO₃, LiOH, LiNO₃, and CH₃COOLi.

20. The method of claim 15, wherein the predetermined temperature is in a range of 700° C. to 1200° C. and the predetermined time is in a range of 8 hrs to 15 hrs.
